(19) United States
(12) Patent Application Publication
(10) Pub. No.: US 2025/0388216 A1
(43) Pub. Date: Dec. 25, 2025

(54) Method and Device for Dealing with Emergency Situation of Driver

(71) Applicants: Hyundai Motor Company, Seoul (KR); Kia Corporation, Seoul (KR)

(72) Inventors: Jee Eun Lee, Hwaseong-Si (KR); Kangin Lee, Hwaseong-Si (KR); Yonggwon Jeon, Hwaseong-Si (KR)

(21) Appl. No.: 18/943,231

(22) Filed: Nov. 11, 2024

(30) Foreign Application Priority Data
Jun. 25, 2024 (KR) 10-2024-0082335

(51) Int. Cl. B60W 40/08; B60W 50/14; G05D 1/227; G05D 109/10; G05D 111/30; G06V 10/82; G06V 20/59; G06V 40/16

(52) U.S. Cl. CPC B60W 40/08; B60W 50/14; G05D 1/2272; G06V 10/82; G06V 20/597; G06V 40/174; G06V 40/178; B60W 2050/146; B60W 2420/403; B60W 2540/221; B60W 2556/45; G05D 2109/10; G05D 2111/32

(57) ABSTRACT

Provided are a method and a device for managing emergency situations. The method may include: obtaining image data representing one or more photographic images of a driver of a vehicle; determining that the driver satisfies an age threshold; determining an emotion classification of the driver; determining a value associated with a heart rate of the driver, wherein the value associated with the heart rate corresponds to the image data; determining, based on the driver satisfying the age threshold, based on the emotion classification, and based on the heart rate, presence of an emergency situation; outputting a first request for a user response from the driver; and transmitting, to an emergency dispatch service provider and based on receiving no user response from the driver within a predetermined time period after the first request is output, an emergency rescue request.

### CROSS-REFERENCE TO RELATED APPLICATION

This application claims priority to and the benefit of Korean Patent Application No. 10-2024-0082335 filed in the Korean Intellectual Property Office on Jun. 25, 2024, the entire contents of which are incorporated herein by reference.

### TECHNICAL FIELD

The present disclosure relates to a method and a device for vehicle emergency management, and more particularly, to a method and a device for managing a driver's emergency situation.

### BACKGROUND

When a driver experiences an emergency situation, such as shock, fainting, or a cardiac arrest, during a vehicle operation, it can lead to a serious traffic accident. When a driver loses consciousness, he or she may lose control of the vehicle, thereby increasing the risk of the vehicle colliding with other vehicles or pedestrians and possibly resulting in loss of life and property damage. For this reason, the need for emergency management during a vehicle operation is important.

### SUMMARY

The present disclosure attempts to provide a driver emergency situation dealing method and device that may quickly and accurately recognize and deal with a driver emergency situation that may occur during a vehicle operation by detecting a driver's state in a non-contact manner using an in-vehicle camera.

According to one or more example embodiments of the present disclosure, a method performed by an apparatus of a vehicle may include: obtaining, via a camera of the vehicle, image data representing one or more photographic images of a driver of the vehicle; determining, based on the image data having one or more pre-determined image characteristics, that the driver satisfies an age threshold; determining, based on performing a facial expression analysis on the image data, an emotion classification of the driver; determining a value associated with a heart rate of the driver, wherein the value associated with the heart rate corresponds to the image data; determining, based on the driver satisfying the age threshold, based on the emotion classification, and based on the heart rate, presence of an emergency situation; outputting, via a user interface of the vehicle and based on the presence of the emergency situation, a first request for a user response from the driver; and transmitting, to an emergency dispatch service provider and based on receiving no user response from the driver within a predetermined time period after the first request is output, an emergency rescue request.

The method may further include: outputting, via the user interface of the vehicle and based on presence of a second emergency situation, a second request for a user response from the driver; outputting, via the user interface and based on receiving a user response to the second request, a third request for an indication of consent by the driver to transferring a right of control of the vehicle; and transferring, based on receiving the indication of consent, the right of control of the vehicle to an entity different from the driver.

The entity may include a remote server that is configured to control the vehicle remotely.

The entity may include a computing device located in the vehicle and configured to control the vehicle to perform autonomous driving.

The method may further include: outputting, via the user interface and based on receiving no user response from the driver within the predetermined time period, a second request for an indication of consent by the driver to transferring a right of control of the vehicle; and based on not receiving the indication of consent within the predetermined time period, obtaining, via the camera, additional image data representing one or more additional photographic images of the driver and confirming, based on the additional image data, presence of the emergency situation.

The one or more pre-determined image characteristics may be associated with at least one of hair of the driver or a wrinkle of the driver. Determining that the driver satisfies the age threshold may include: estimating an age of the driver based on the image data by using a first model trained to identify presence of gray hair and presence of wrinkles.

Determining the emotion classification may include: determining, based on the image data, a global feature, to which multi-scale is applied, from the image data via a plurality of multi-scale blocks with different sized filters; determining a local feature, to which attention is applied, from the image data, via a convolutional block attention module (CBAM) that includes a channel attention module and a spatial attention module, and sequentially applies the channel attention module and the spatial attention module; inputting the global feature and the local feature into a graph convolutional network (GCN) combiner to perform feature combination; and determining the emotion classification of the driver by using a classifier based on a result of the feature combination.

The method may further include: selecting a superior feature by applying a feature selector to the global feature and the local feature; and extracting, from the global feature, a patch image of a face corresponding to a location of the superior feature. Performing the feature combination may include: performing the feature combination by inputting a feature acquired by enlarging the patch image and applying attention to the enlarged patch image to the GCN combiner with the global feature and the local feature.

Determining the heart rate of the driver may include: obtaining a first band image and a second band image of different bands from the image data; measuring a first remote heartbeat signal for the first band image; measuring a second remote heartbeat signal for the second band image; determining, based on the first band image, a first quality score; determining, based on the second band image, a second quality score; determining, based on the first remote heartbeat signal and the first quality score, a first effective heart rate section; determining, based on the second remote heartbeat signal and the second quality score, a second effective heart rate section; and determining, based on the first effective heart rate section and the second effective heart rate section, a complementary heart rate.

The determination of the first quality score and the second quality score may include at least one of: determining a first movement quality score and a second movement quality score; determining a first lighting quality score and a second lighting quality score; and determining a first signal quality score and a second signal quality score.

According to one or more example embodiments of the present disclosure, an apparatus may include: one or more processors; and memory storing instructions that, when executed by the one or more processors, cause the apparatus to: obtain, via a camera of a vehicle, image data representing one or more photographic images of a driver of the vehicle; determine, based on the image data having one or more pre-determined image characteristics, that the driver satisfies an age threshold; determine, based on performing a facial expression analysis on the image data, an emotion classification of the driver; determine a value associated with a heart rate of the driver, wherein the value associated with the heart rate corresponds to the image data; determine, based on the driver satisfying the age threshold, based on the emotion classification, and based on the heart rate, presence of an emergency situation; output, via a user interface of the vehicle and based on the presence of the emergency situation, a first request for a user response from the driver; and transmit, to an emergency dispatch service provider and based on receiving no user response from the driver within a predetermined time period after the first request is output, an emergency rescue request.

The instructions, when executed by the one or more processors, may further cause the apparatus to: output, via the user interface and based on receiving a user response from the driver within the predetermined time period, a second request for an indication of consent by the driver to transferring a right of control of the vehicle, and transfer, based on receiving the indication of consent, the right of control of the vehicle to an entity different from the driver.

The entity may include a remote server that is configured to control the vehicle remotely.

The entity may include a computing device located in the vehicle and configured to control the vehicle to perform autonomous driving.

The instructions, when executed by the one or more processors, may further cause the apparatus to: output, via the user interface and based on receiving no user response from the driver within the predetermined time period, a second request for an indication of consent by the driver to transferring a right of control of the vehicle; and based on not receiving the indication of consent within the predetermined time period, obtain, via the camera, additional image data representing one or more additional photographic images of the driver and confirm, based on the additional image data, presence of the emergency situation.

The one or more pre-determined image characteristics may be associated with at least one of hair of the driver or a wrinkle of the driver. The instructions, when executed by the one or more processors, may cause the apparatus to determine that the driver satisfies the age threshold by: estimating an age of the driver based on the image data by using a first model trained to identify presence of gray hair and presence of wrinkles.

The instructions, when executed by the one or more processors, may cause the apparatus to determine the emotion classification by: determining, based on the image data, a global feature, to which multi-scale is applied, from the image data via a plurality of multi-scale blocks with different sized filters; determining a local feature, to which attention is applied, from the image data, via a convolutional block attention module (CBAM) that includes a channel attention module and a spatial attention module, and sequentially applies the channel attention module and the spatial attention module; inputting the global feature and the local feature into a graph convolutional network (GCN) combiner to perform feature combination; and determining the emotion classification of the driver by using a classifier based on a result of the feature combination.

The instructions, when executed by the one or more processors, may further cause the apparatus to: select a superior feature by applying a feature selector to the global feature and the local feature; and extract, from the global feature, a patch image of a face corresponding to a location of the superior feature. The instructions, when executed by the one or more processors, may cause the apparatus to perform the feature combination by: performing the feature combination by inputting a feature acquired by enlarging the patch image and applying attention to the enlarged patch image to the GCN combiner with the global feature and the local feature.

The instructions, when executed by the one or more processors, may cause the apparatus to determine the heart rate of the driver by: obtaining a first band image and a second band image of different bands from the image data; measuring a first remote heartbeat signal for the first band image; measuring a second remote heartbeat signal for the second band image; determining, based on the first band image, a first quality score; determining, based on the second band image, a second quality score; determining, based on the first remote heartbeat signal and the first quality score, a first effective heart rate section; determining, based on the second remote heartbeat signal and the second quality score, a second effective heart rate section; and determining, based on the first effective heart rate section and the second effective heart rate section, a complementary heart rate.

The instructions, when executed by the one or more processors, may cause the apparatus to determine the first quality score and the second quality score by: determining a first movement quality score and a second movement quality score; determining a first lighting quality score and a second movement lighting score; and determining a first signal quality score and a second signal quality score.

### BRIEF DESCRIPTION OF THE DRAWINGS

FIG. 1 is a diagram illustrating a device for managing an emergency situation of a driver according to an exemplary embodiment.

FIG. 2 is a diagram illustrating a method of managing an emergency situation of a driver according to an exemplary embodiment.

FIG. 3 is a diagram illustrating a method of managing an emergency situation of a driver according to an exemplary embodiment.

FIG. 4 is a diagram illustrating a method of managing an emergency situation of a driver according to an exemplary embodiment.

FIG. 5 is a diagram illustrating a method of managing an emergency situation of a driver according to an exemplary embodiment.

FIG. 6 is a diagram illustrating a method of managing an emergency situation of a driver according to an exemplary embodiment.

FIG. 7 is a diagram illustrating an example of implementation of the device and the method of managing the emergency situation of the driver according to the exemplary embodiment.

FIG. 8 is a diagram illustrating an example of implementation of the device and the method of managing the emergency situation of the driver according to the exemplary embodiment.

FIG. 9 is a diagram illustrating a computing device according to an exemplary embodiment.

### DETAILED DESCRIPTION

Hereinafter, the present disclosure will be described more fully hereinafter with reference to the accompanying drawings, in which one or more example embodiments of the disclosure are shown. As those skilled in the art would realize, the described exemplary embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used only to discriminate one component from another component.

Terms such as “part,” “unit,” “module,” and the like in the specification may refer to a unit capable of performing at least one function or operation described herein, which may be implemented in hardware or circuitry, software, or a combination of hardware or circuitry and software. In addition, at least some of the configurations or functions of a device and a method of managing an emergency situation of a driver according to exemplary embodiments described below may be implemented as programs or software, and the programs or software may be stored on a computer-readable medium.

To manage a driver's emergency, it may be necessary to quickly and accurately identify or determine the driver's state of unconsciousness or drowsiness. In some implementations, a monitoring device may be worn on the driver's body to monitor the state of the wearer. However, such a device may have limited utility and fail to detect an emergency if the monitoring device is not worn correctly on the driver's body, or if the driver intentionally chooses not to wear the monitoring device.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

### {Update the Highlighted Field in the Context of Specification}

Based on one or more features (e.g., determining presence of an emergency situation) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining presence of an emergency situation) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining presence of an emergency situation) described herein.

Minimum risk maneuver (MRM) operation(s) may also be controlled, for example, based on one or more features (e.g., determining presence of an emergency situation) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining presence of an emergency situation) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining presence of an emergency situation) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

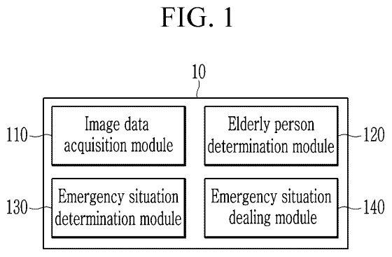

FIG. 1 is a diagram illustrating a device for managing an emergency situation of a driver according to an exemplary embodiment.

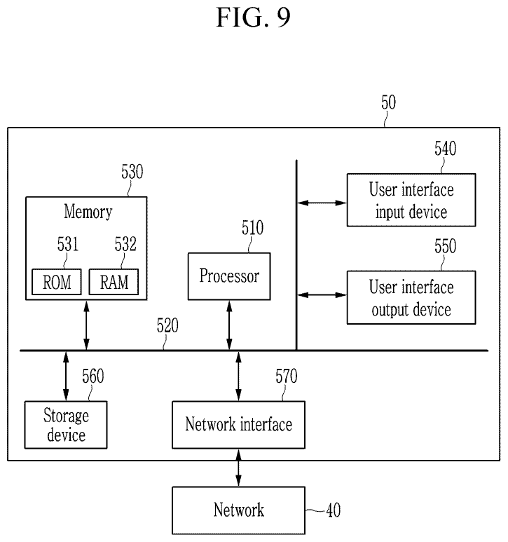

Referring to FIG. 1, a device 10 for managing an emergency situation of a driver according to an exemplary embodiment may execute program codes loaded into one or more memory devices via one or more processors. For example, the device 10 for managing the emergency situation of the driver may be implemented as a computing device 50, such as that described later with reference to FIG. 9. In this case, the one or more processors may correspond to a processor 510 of the computing device 50, and the one or more memory devices may correspond to a memory 520 of the computing device 50. The program code may be executed by the one or more processors to perform a function to recognize a driver's situation occurring in a vehicle and managing an emergency situation. The term “module” is used herein to logically distinguish between these functions executed by the program code.

The device 10 for managing the emergency situation of the driver according to the exemplary embodiment may include an image data acquisition module 110, an elderly person determination module 120, an emergency situation determination module 130, and an emergency situation dealing module 140. Each of the modules or components of the device 10 may be implemented with software, hardware, or a combination of both. One of more of the modules or components of the device 10 may be implemented with one or more processors.

The image data acquisition module 110 may photograph a driver by using a camera installed in the inside of a vehicle and acquire first image data. Herein, the first image data is data about an image including a facial region for performing facial expression recognition of the driver and a skin region for performing heart rate calculation, and may be in the form of a still image or a video including a plurality of frames.

The elderly person determination module 120 may remove noise from the first image data acquired by the image data acquisition module 110 to acquire second image data. Specifically, the elderly person determination module 120 may apply some restoration algorithms to the first image data to compensate for shaking, or apply some light correction technique to the first image data to remove light noise, to acquire the second image data with noise, such as shaking and light, removed.

The elderly person determination module 120 may determine whether the driver is an elderly person (e.g., whether the driver satisfies an age requirement) based on an elderly person's recognizable point (e.g., one or more pre-determined image characteristics) in the second image data. In some exemplary embodiments, the elderly person's recognizable point may include hair regions and wrinkle regions. The elderly person determination module 120 may predict whether the driver is an elderly person from the second image data by using a first model trained to predict (e.g., identify) the presence of gray hair and wrinkles from the point. In some exemplary embodiments, the first model may include a convolutional neural network (CNN) model, but the scope of the disclosure is not limited thereto.

The emergency situation determination module 130 may perform an emotion classification of the driver using facial expression recognition on the second image data.

The emergency situation determination module 130 may extract a global feature, to which multi-scale is applied, from the second image data via a multi-scale module including a plurality of multi-scale blocks with different sized filters. Here, the global feature may be a feature (or first-level feature) that is extracted from the entire facial region. The multi-scale module may capture spatial context from the image by using multiple sized filters, without being limited to a single sized filter. The multi-scale module may include a plurality of multi-scale blocks having different sized filters, and each of the multi-scale blocks is capable of extracting different sized features for the input data. For example, the multi-scale module may include a first multi-scale block to a fourth multi-scale block, and the first multi-scale block and the second multi-scale block are implemented with 3×3 convolutional, 256 filters, and the third multi-scale block and the fourth multi-scale block are implemented with 3×3 convolutional, 512 filters. The global features may be extracted from the first multi-scale block to the fourth multi-scale block.

The emergency situation determination module 130 may extract local features to which attention is applied by the convolutional block attention module (CBAM), from the second image data. The local features may be features (or second-level features) extracted from partial region of the face. The CBAMs may include two types of attention mechanisms, a channel attention module and a spatial attention module, and may apply the channel attention module and the spatial attention module sequentially. In other words, a CBAM may first apply the channel attention, which learns the importance of each channel and adjusts the activation of each channel for each channel, and then apply the spatial attention, which learns the importance of each region of the image and adjusts the activation for each location for a result of the application of the channel attention. By adding the attention to the existing convolutional layer in this way, the neural network may better focus on the important parts of the input image and improve the performance of the convolutional neural network. For example, the facial region may include, for example, a region LE including a left eye, a region RE including a right eye, a region NO including a nose, a region LM including a left portion of a mouth, and a region RM including a right portion of a mouth, as local regions. The local feature may be extracted via the first CBAM to the fourth CBAM, which have the region LE including the left eye, the region RE including the right eye, the region NO including the nose, the region LM including the left portion of the mouth, and the region RM including the right portion of the mouth as input. The first to fourth CBAMs are sequential, and each of the first CBAM to the fourth CBAM may be implemented as a 3×3 convolutional, 256 filter.

The emergency situation determination module 130 may input the global features and local features into a graph convolutional network (GCN) combiner to perform feature combining, and may perform emotion classification of the driver through a classifier based on the combined features. Specifically, the emergency situation determination module 130 may construct a graph with nodes including feature vectors and edges representing association relationships between the nodes, combine the feature of each node with the feature of the neighboring node, and generate a new feature representation of the center node based on the feature of the neighboring node. Thus, the features of the nodes in the graph and the association relationships between the features may be learned. The global features combined by the graph convolutional network combiner and the local features combined by the graph convolutional network combiner may be combined by the graph convolutional network combiner again to be generated as final features.

In some exemplary embodiments, the emergency situation determination module 130 may apply a feature selector to the global features and local features to select superior features. For example, the emergency situation determination module 130 may primarily select features corresponding to a top certain percentage of global features that have high classification reliability values and use features corresponding to a bottom certain percentage of global features that are determined to have low classification reliability values as mean squared error loss (MSE) loss. For example, a predetermined number of 12 features from the global features may be selected primarily, and among the selected features, the features corresponding to the bottom 25% of the features determined to have low classification reliability may be used as the MSE loss. On the other hand, the emergency situation determination module 130 may primarily select a predetermined number of features from the local features, and secondarily select features corresponding to a top certain percentage of the selected features that are determined to have high classification reliability. For the secondarily selected features, feature combination may be performed by using a graph convolutional network combiner. For example, a predetermined number of 12 features are selected from the local features primarily, and among the selected local features, the top 25% of the features that are determined to have high classification reliability may be selected secondarily. In addition, among the selected local features, the bottom 25% of features that are determined to have low classification reliability may be used as MSE loss.

The emergency situation determination module 130 may extract a patch image for the face corresponding to the location of a superior feature among the global features. The patch image may be for extracting features that are extracted from a fine region of the face from an image corresponding to the entire facial region. As such, the number of patch regions may be set to be greater than the number of local regions, since the patch regions are intended to take into account fine regions of the face. The emergency situation determination module 130 may perform feature combination by inputting the feature, which is acquired by enlarging the patch image and applying the attention to the enlarged patch image, into a graph convolutional network combiner together with the global features and the local features. The global features combined by the graph convolutional network combiner, the local features combined by the graph convolutional network combiner, and the features acquired by enlarging the patch image and applying the attention to the enlarged patch image may be combined by the graph convolutional network combiner again to be generated as final features.

The emergency situation determination module 130 may classify the driver's emotion as one of anger, disgust, fear, happiness, neutral, sadness, and surprise by inputting the final features combined by the graph convolutional network combiner into a classifier.

Meanwhile, the emergency situation determination module 130 may calculate the heart rate of the driver for the second image data. The emergency situation determination module 130 may acquire a first band image and a second band image of different bands from the second image data, and may measure a first remote heartbeat signal and a second remote heartbeat signal for the first band image and the second band image, respectively. For example, the first band image may include a visible light image and the second band image may include an infrared image. Of course, the scope of the present disclosure is not limited thereto, and the emergency situation determination module 130 may acquire an image corresponding to any first frequency band that is not necessarily limited to the visible light band, and an image having any second frequency band that is different from the first frequency band but is not necessarily limited to the infrared band. The emergency situation determination module 130 may acquire average brightness values for the skin regions of the facial regions acquired from the first band image and the second band image, perform signal processing preprocessing including removing trend lines and bandpass filtering, and extract a remote heartbeat signal by using an algorithm for extracting a heartbeat signal. In some exemplary embodiments, the algorithm for extracting the heartbeat signal may include at least one of chrominance-based method (Chrom), optical noise injection technique (ONIT), principal component analysis (PCA), plane orthogonal to skin-tone (POS), Green Method, and DistancePPG. The emergency situation determination module 130 may measure the remote heart rate by performing a frequency analysis on the extracted remote heartbeat signal and calculating the maximum frequency component.

The emergency situation determination module 130 may compute a first quality score and a second quality score for the first band image and the second band image, respectively, and select a first effective heart rate section based on the first remote heartbeat signal and the first quality score. Additionally, the emergency situation determination module 130 may select a second effective heart rate section based on the second remote heartbeat signal and the second quality score. The quality score may be used to select an effective heart rate section that is determined to be a suitable section for analysis among the remote heartbeat signals measured in the acquired image to increase the reliability of the heart rate acquisition.

In some exemplary embodiments, the first quality score may include a first movement quality score as an index for measuring noise caused by head movements of the driver, muscle movements in the face due to conversation or facial expressions, and the like. For example, a first movement quality score may be computed for the first band image by measuring changes in facial feature points in adjacent frames to each other, and movement intensity may be measured by using the first movement quality score. That is, changes in facial feature points in adjacent frames may be measured to quantitatively measure facial movements caused by facial expressions and conversations that are noise factors in remote heart rate measurements. In some exemplary embodiments, the second quality score may include a second movement quality score that is computed for the second band image in substantially the same manner as the first movement quality score.

In some exemplary embodiments, the first quality score may include a first lighting quality score as an index for measuring noise due to lighting changes. For example, the first lighting quality score may be computed by measuring the amount of brightness variation, that is, measuring time-series illumination differences, for the first band image. For example, the brightness information of the input may be extracted from the Y values in the YCbCr color space for an RGB camera, or the brightness information of the input may be extracted from a single channel image for an NIR camera, and the extracted brightness information may be utilized as a quality score to quantitatively provide the effectiveness of the extracted heartbeat signal. In some exemplary embodiments, the second quality score may include a second lighting quality score that is computed for the second band image in substantially the same manner as the first lighting quality score.

In some exemplary embodiments, the first quality score may include a first signal quality score that measures the quality of the heartbeat signal by using a frequency analysis of the remote heartbeat signal and an SNR index. For example, a first signal quality score may be computed by measuring a signal quality based on a frequency spectral characteristic of the remote heartbeat signal for the first band image. A heartbeat cycle is characterized by a gradual change in BPM over a time series, and for example, a change in BPM in 10-second time series may be 6 BPM or less. This indicates that the intensity of the frequency component corresponding to the heartbeat signal is high compared to other frequency components, which may indicate that the frequency power of the heart rate band is high in the frequency spectrum. Accordingly, the remote heartbeat signal quality may be evaluated by considering the remote heart rate bandwidth as the signal and considering the remaining bandwidth as noise. In some exemplary embodiments, the second quality score may include a second signal quality score that is computed for the second band image in substantially the same manner as the first signal quality score.

The emergency situation determination module 130 may predict an error value from the model trained by the first quality score and the second quality score, and select a first effective heart rate section and a second effective heart rate section based on the predicted error value. Specifically, the section in which the predicted error value is equal to or less than a predetermined first threshold may be included in the first effective heart rate section and be used for calculating the heart rate, and the section in which the predicted error value exceeds the predetermined first threshold may not be included in the first effective heart rate section and not used for calculating the heart rate. The first threshold may be determined as an error value corresponding to the top x % (wherein x is a positive real number) of the smallest error values of the predicted results from the model trained using the first quality score. For example, the first threshold may be an error value corresponding to the top 10% of the smallest error values of the predicted results from the model trained using the first quality score, and the heartbeat signal with the top 10% reliability may be selected as the first effective heart rate section. The second effective heart rate section may be selected in the same manner as the selection of the first effective heart rate section.

Based on the selected first effective heart rate section and second effective heart rate section, the emergency situation determination module 130 may calculate a complementary heart rate as the driver's heart rate. As used herein, the complementary heart rate may mean a heart rate with improved accuracy by taking into account the mutual characteristics of the remote heartbeat signals for different wavelength bands. Thus, compared to the case where the heart rate is calculated for a single band, by using the two bands in complementary combination, the section in which the performance of the acquired signal deteriorates due to noise in each band may be replaced by a section based on another band with good performance, and the time width over which the heart rate is extracted may be expanded by complementarily using the two bands. The emergency situation determination module 130 may calculate a complementary heart rate by using a predetermined weight when a portion of the first effective heart rate section and a portion of the second effective heart rate section overlap and the heart rates predicted from the overlapping sections are different.

The emergency situation determination module 130 may determine that the driver is in an emergency based on the results of the emotion classification and the heart rate. Specifically, the emergency situation determination module 130 may determine whether the driver is in an emergency situation based on the results of the emotion classification and predetermined criteria per heart rate.

When it is determined that the driver is in an emergency situation, the emergency situation dealing module 140 may output a first request requesting a response from the driver. If no response to the first request is received from the driver within a predetermined time period, the emergency situation dealing module 140 may transmit a request for emergency rescue to an external system. In some exemplary embodiments, the external system may include a system providing a call center or a system providing an ambulance. The external system may be, for example, an emergency dispatch service provider. The first request may be output through a user interface of the vehicle. The user interface may be a device through which a human user can interact with a device (e.g., the vehicle). The user interface may be located inside the vehicle, for example, at a dashboard, a console, a center console an instrument panel, a side-view mirror, a rear-view mirror, a steering wheel, a car seat, a glove compartment, an arm rest, a headrest, an interior wall, a ceiling, etc. The user interface may include an input interface that can receive an input from the human user and/or an output interface through which data or information can be output to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, an actuator (e.g., for touch feedback or haptics), etc. The first request may be output through one or more output interfaces of the vehicle. The first request may be output visually, audibly, and/or via touch feedback (e.g., haptics).

When the driver responds to the first request within the predetermined time period, the emergency situation dealing module 140 may output a second request to the driver requesting a response as to whether the driver consents to the transferring of the right of the control of the vehicle. The driver's response may be received via one of the input interfaces discussed herein. If the driver's response indicates that the driver consents to the transferring of the right of control of the vehicle, the emergency situation dealing module 140 may perform an operation to transfer the right of the control of the vehicle to another entity. On the other hand, if the driver's response indicates that the deriver does not consent to the transferring of the right of the control of the vehicle, the process of photographing the driver by using the camera and determining whether the driver is in an emergency situation may be repeatedly (e.g., continuously) performed.

The emergency situation dealing module 140 may transfer a right of control to a remote server that may remotely control the vehicle. For example, the transferring of the right of the control may be made to a remote server outside of the vehicle to perform vehicle control for the emergency situation.

In some exemplary embodiments, the emergency situation dealing module 140 may transfer a right of control to an in-vehicle computing device that is capable of controlling the vehicle to perform autonomous driving. For example, the transferring of the right of the control may be made such that the vehicle autonomously performs vehicle control.

According to the present exemplary embodiment, it is possible to detect the driver's emergency situation quickly in a non-contact manner through emotion classification and heart rate calculation by recognizing the driver's facial expressions, and provide a management method suitable to the emergency situation, such as transferring a right of control, based on the driver's state of consciousness or cognition.

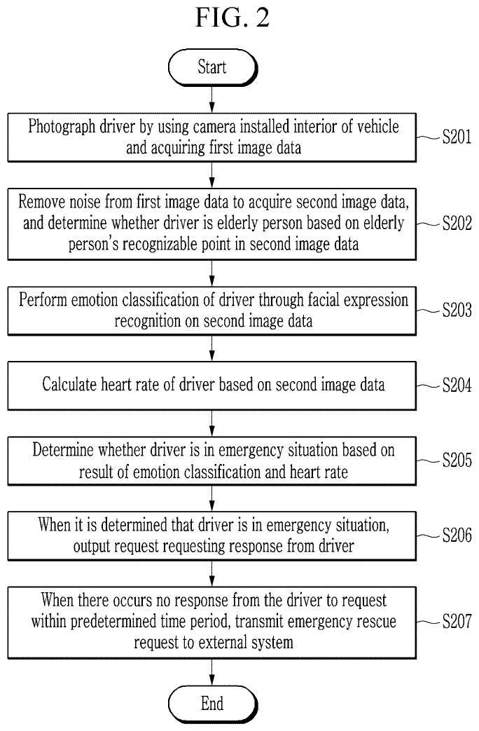

FIG. 2 is a diagram illustrating a method of managing emergency situation of a driver according to an exemplary embodiment.

Referring to FIG. 2, a method of managing emergency situation of a driver according to an exemplary embodiment may include photographing a driver by using a camera installed in an inside of a vehicle and acquiring first image data (S201), removing noise from the first image data to acquire second image data, and determining whether the driver is an elderly person based on an elderly person's recognizable point in the second image data (S202), performing an emotion classification of the driver through facial expression recognition on the second image data (S203), calculating a heart rate of the driver based on the second image data (S204), determining whether the driver is in an emergency situation based on a result of the emotion classification and the heart rate (S205), when it is determined that the driver is in the emergency situation, outputting a request requesting a response from the driver (S206); and when there occurs no response from the driver to the request within a predetermined time period, transmitting an emergency rescue request (e.g., a distress signal) to an external system (S207).

For further details of the method, reference may be made to the description of the exemplary embodiments described herein, so that duplicative descriptions are omitted herein.

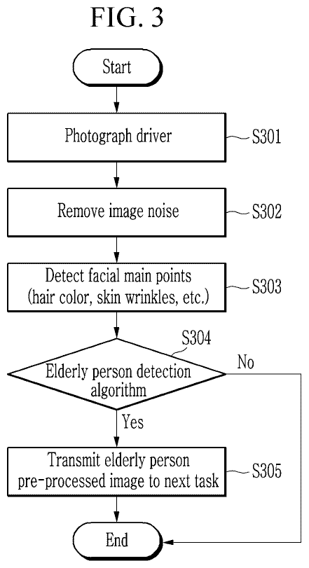

FIG. 3 is a diagram illustrating a method of managing emergency situation of a driver according to an exemplary embodiment.

Referring to FIG. 3, a method of managing emergency situation of a driver according to an exemplary embodiment may include photographing a driver by using a camera installed in an inside of a vehicle (S301), removing image noise from the photographed image (S302), detecting facial main points (e.g., hair color, and skin wrinkles) in the image in which the noise has been removed (S303), and performing an elderly person detection algorithm to determine whether the driver is an elderly person (S304).

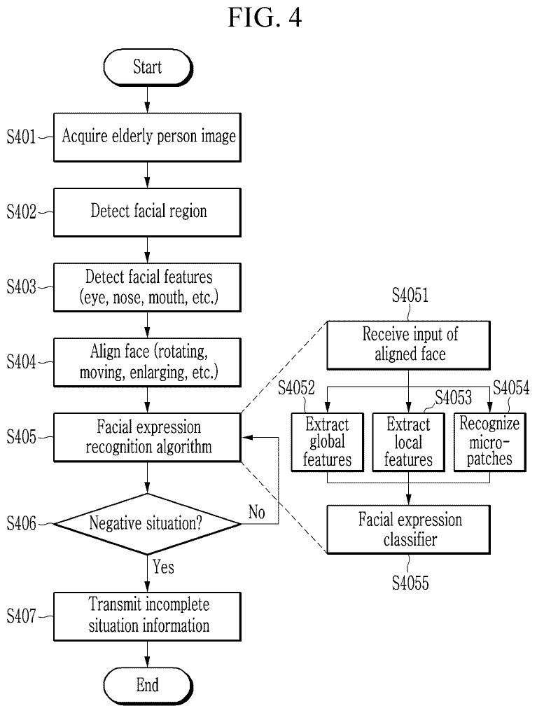

When it is determined that the driver is an elderly person (S304, Yes), the method may perform transmitting an elderly person pre-processed image to a next task (S305). The next task is described later with reference to FIG. 4.

FIG. 4 is a diagram illustrating a method of managing an emergency situation of a driver according to an exemplary embodiment.

Referring to FIG. 4, a method of managing emergency situation of a driver according to an exemplary embodiment may include acquiring an elderly person image transmitted according to operation 305 of FIG. 3 (S401), detecting a facial region in the elderly person image (S402); detecting facial features (e.g., eyes, nose, and mouth) in the facial region (S403), aligning the face by rotating, moving, enlarging, or the like based on the facial features (S404), and extracting feature values from the aligned face and performing a facial expression recognition algorithm (S405).

In some exemplary embodiments, operation S405 may include receiving input of the face aligned based on the facial features (S4051), extracting global features (S4052), extracting local features (S4053), recognizing micro-patches (S4054), and performing emotion classification by using a facial expression classifier (S4055).

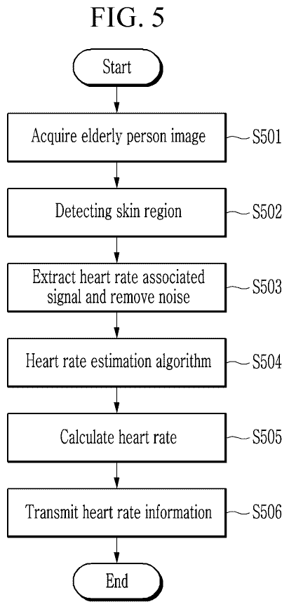

The method may determine whether the driver expresses a negative situation as a result of the emotion classification using the facial expression classifier. When it is determined that the driver expresses the negative situation (S406, Yes), the method may perform transmitting incomplete situation information to a next task (S407). The next task is described later with reference to FIG. 5. In contrast, when it is determined that the driver is not in the negative situation (S406, No), the method may proceed to operation S405.

FIG. 5 is a diagram illustrating a method of managing an emergency situation of a driver according to an exemplary embodiment.

Referring to FIG. 5, a method of managing emergency situation of a driver according to an exemplary embodiment may include acquiring an elderly person image transmitted according to operation S305 of FIG. 3 (S501), detecting a skin region from the elderly person image from which a heart rate parameter may be extracted (S502), extracting a heart rate associated signal from the skin region and performing noise removal (S503), performing a heart rate estimation algorithm (S504), calculating a heart rate by using the heart rate estimation algorithm (S505), and transmitting heart rate information as an index for determining an unstable situation (S506).

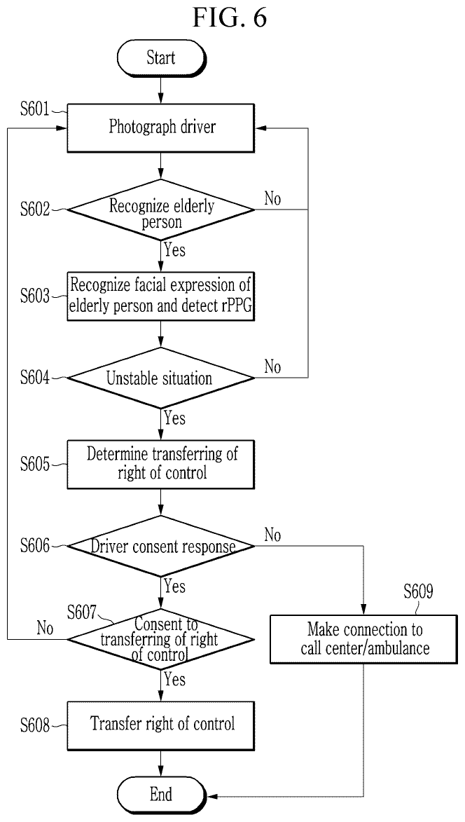

FIG. 6 is a diagram illustrating a method of managing an emergency situation of a driver according to an exemplary embodiment.

Referring to FIG. 6, a method of managing emergency situation of a driver according to an exemplary embodiment may include photographing a driver by using a camera installed in an inside of a vehicle (S601) and performing elderly person recognition on the photographed image (S602).

When the elderly person recognition fails in the photographed image (S602, No), the method may proceed to operation S601 to continue monitoring through the camera. In contrast, when the elderly person recognition succeeds in the photographed image (S602, Yes), the method may perform recognizing a facial expression of the elderly person and detecting rPPG (S603) and determining whether the driver is in an unstable situation during driving based on the detected facial expression and rPPG (S604).

When it is determined that the driver is not in the unstable situation (S604, No), the method may proceed to operation S601 to continue monitoring through the camera. Alternatively, when it is determined that the driver is in the unstable situation (S604, Yes), the method may perform determining a transfer of control and requiring a response from the driver (S605) and determining when a driver consent response has occurred (S606).

When it is determined that the driver consent response has not occurred (S606, No), the method may recognize that the driver is in a dangerous situation and perform a connection to a call center or an ambulance in recognition of the dangerous situation (S609). In contrast to this, when it is determined that the driver consent response has occurred (S606, Yes), the method may perform determining whether the driver consents to the transferring of the right of the control (S607). When it is determined that the driver does not consent to the transferring of the right of the control (S607, No), the method may proceed to operation S601 to continue monitoring through the camera. In contrast to this, when it is determined that the driver consents to the transferring of the right of the control (S607, Yes), the method may perform transferring the right of the control (S608).

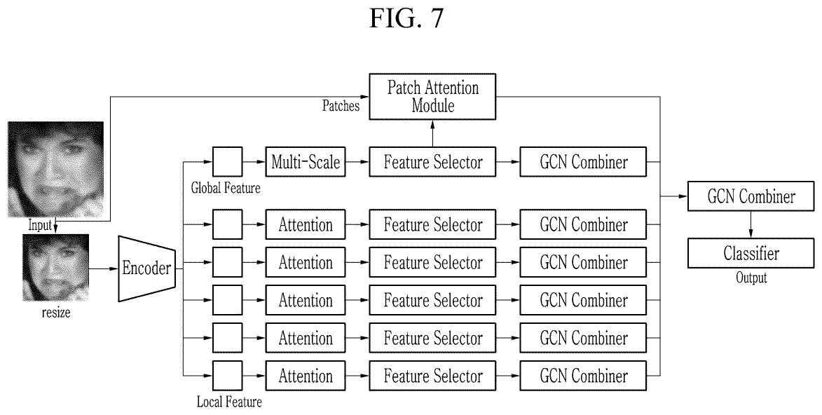

FIG. 7 is a diagram illustrating an example of implementation of the device and the method of managing emergency situation of the driver according to the exemplary embodiment.

Referring to FIG. 7, a global feature to which a multi-scale is applied may be extracted via the multi-scale module, and a local feature to which an attention is applied may be extracted via the CBAM. Superior features may be selected by applying the feature selector to the global features and the local features, and the global features combined by the graph convolutional network combiner and the local features combined by the graph convolutional network combiner may be combined by the graph convolutional network combiner again to be generated as final features.

Meanwhile, a patch image of the face corresponding to the location of the superior feature among the global features is extracted by the feature selector, and the feature acquired by enlarging the patch image and applying the attention to the enlarged patch image may be input to the graph convolutional network combiner together with the global features and the local features to perform feature combination. The global features combined by the graph convolutional network combiner, the local features combined by the graph convolutional network combiner, and the features acquired by enlarging the patch image and applying the attention to the enlarged patch image may be combined by the graph convolutional network combiner again to be generated as final features.

The final features combined by a graph convolutional network combiner are input into the classifier, to classify the driver's emotion into one of anger, disgust, fear, happiness, neutral, sadness, and surprise.

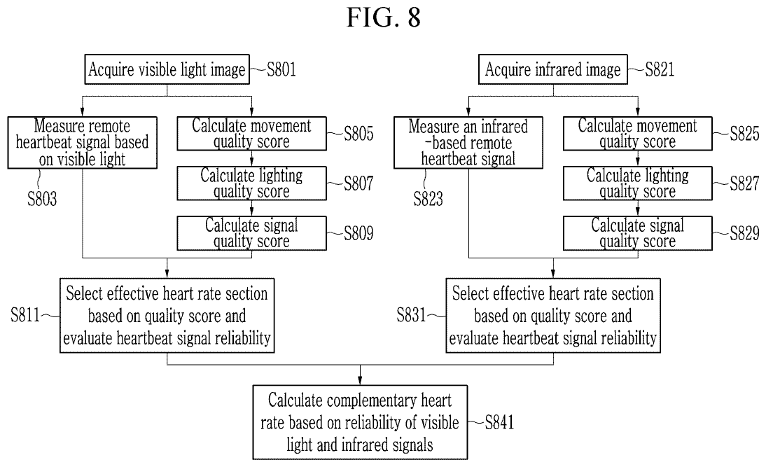

FIG. 8 is a diagram illustrating an example of implementation of the device and the method of managing emergency situation of the driver according to the exemplary embodiment.

Referring to FIG. 8, the emergency situation determination module 130 may acquire a visible light image in operation S801 and measure a remote heartbeat signal based on the visible light in operation S803. Meanwhile, the emergency situation determination module 130 may calculate a movement quality score, calculate a lighting quality score, and calculate a signal quality score in operation S805, operation S807, and operation S809, respectively. Then, the emergency situation determination module 130 may select an effective heart rate section based on the quality score calculated in operation S811 and evaluate heartbeat signal reliability.

Meanwhile, the emergency situation determination module 130 may acquire an infrared image in operation S821 and measure an infrared-based remote heartbeat signal in operation S823. Meanwhile, the emergency situation determination module 130 may calculate a movement quality score, calculate a lighting quality score, and calculate a signal quality score in operation S825, operation S827, and operation S829, respectively. Then, the emergency situation determination module 130 may select an effective heart rate section based on the quality score calculated in operation S821 and evaluate the heartbeat signal reliability.

Then, the emergency situation determination module 130 may calculate a complementary heart rate based on the reliability of the visible light and infrared signals in operation S841.

FIG. 9 is a diagram illustrating a computing device according to an exemplary embodiment.

Referring now to FIG. 9, the method and the device of managing the emergency situation of the driver according to the exemplary embodiments may be implemented by using a computing device 50.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive a signal with another entity through the network 40.

The processor 510 may be implemented in various types, such as a micro controller unit (MCU), application processor (AP), a central processing unit (CPU), a graphic processing unit (GPU), a neutral processing unit (NPU), and a quantum processing unit (QPU), and may be a predetermined semiconductor device executing commands stored in the memory 530 or the storage device 560. The processor 510 may be configured to implement the function and the methods described above with reference to FIGS. 1 to 8.

The memory 530 and the storage device 560 may include various forms of volatile or non-volatile storage media. For example, the memory may include a read only memory (ROM) 531 and a random-access memory (RAM) 532. In some exemplary embodiments, the memory 530 may be located inside or outside the processor 510, and the memory 530 may be connected with the processor 510 through already known various means.

In some exemplary embodiments, at least some configurations or functions of the method and the device of managing the emergency situation of the driver according to the exemplary embodiments may be implemented as programs or software executed on the computing device 50, and the programs or software may be stored on a computer-readable medium. Specifically, a computer-readable medium according to the exemplary embodiment may record a program for executing the operations included in an implementation of the method and the device of managing the emergency situation of the driver according to the exemplary embodiments on a computer including the processor 510 executing a program or commands stored in the memory 530 or the storage device 560.

In some exemplary embodiments, at least some configurations or functions of the method and the device of managing the emergency situation of the driver according to the exemplary embodiments may be implemented using hardware or circuit of the computing device 50, or may be implemented as separate hardware or circuit that may be electrically connected to computing device 50.

An exemplary embodiment of the present disclosure provides a method of dealing with an emergency situation of a driver that recognizes a situation of a driver occurring in a vehicle and deals with an emergency situation, the method including: photographing the driver by using a camera installed in an inside of the vehicle and acquiring first image data; removing noise from the first image data to acquire second image data, and determining whether the driver is an elderly person based on an elderly person's recognizable point in the second image data; performing an emotion classification on the driver through facial expression recognition on the second image data; calculating a heart rate of the driver for the second image data; determining, based on a result of the emotion classification and the heart rate, whether the driver is in the emergency situation; when it is determined that the driver is in the emergency situation, outputting a first request requesting a response from the driver; and when there occurs no response of the driver to the first request within a predetermined time period, transmitting an emergency rescue request to an external system.

In some exemplary embodiments, the method may further include: when there occurs the response of the driver to the first request within the predetermined time period, outputting a second request requesting a response from the driver indicating whether the driver consents to transferring a right of control of the vehicle; and when there occurs the response indicating that the driver consents to the transferring of the right of the control of the vehicle, transferring the right of the control of the vehicle to another entity.

In some exemplary embodiments, the transferring of the right of the control of the vehicle to another entity may include transferring the right of the control of the vehicle to a remote server that is capable of controlling the vehicle remotely.

In some exemplary embodiments, the transferring of the right of the control of the vehicle to another entity may include transferring the right of the control to an in-vehicle computing device capable of controlling the vehicle to perform autonomous driving.

In some exemplary embodiments, the method may further include when there occurs the response indicating that the driver does not consent to transferring the right of the control of the vehicle, repeatedly photographing the driver by using the camera and determining whether the driver is in the emergency situation.

In some exemplary embodiments, the elderly person's recognizable point may include hair regions and wrinkle regions, and the determining of whether the driver is the elderly person may include predicting whether the driver is an elderly person from the second image data by using a first model trained to predict presence of gray hair and presence of wrinkles from the point.

In some exemplary embodiments, the performing of the emotion classification on the driver may include: extracting a global feature, to which multi-scale is applied, from the second image data via a multi-scale module including a plurality of multi-scale blocks with different sized filters; extracting a local feature, to which attention is applied, from the second image data, via a convolutional block attention module (CBAM) that includes a channel attention module and a spatial attention module, and sequentially applies the channel attention module and the spatial attention module; inputting the global feature and the local feature into a graph convolutional network (GCN) combiner to perform feature combination; and performing an emotion classification on the driver by using a classifier based on the combined feature.

In some exemplary embodiments, the method may further include: selecting a superior feature by applying a feature selector to the global feature and the local feature; and extracting a patch image of the face corresponding to a location of the superior feature from the global feature, in which the performing the feature combination may include performing the feature combination by inputting the feature acquired by enlarging the patch image and applying attention to the enlarged patch image into the graph convolutional network combiner together with the global feature and the local feature.

In some exemplary embodiments, the calculating of the heart rate of the driver may include: acquiring a first band image and a second band image of different bands from the second image data; measuring a first remote heartbeat signal and a second remote heartbeat signal for the first band image and the second band image, respectively; computing a first quality score and a second quality score for the first band image and the second band image, respectively; selecting a first effective heart rate section based on the first remote heartbeat signal and the first quality score; selecting a second effective heart rate section based on the second remote heartbeat signal and the second quality score; and calculating a complementary heart rate based on the first effective heart rate section and the second effective heart rate section.

In some exemplary embodiments, the computing of the first quality score and the second quality score may include: at least one of computing a first movement quality score and a second movement quality score; computing a first lighting quality score and a second lighting quality score; and computing a first signal quality score and a second signal quality score.

Another exemplary embodiment of the present disclosure provides a device for dealing with an emergency situation of a driver that recognizes a situation of a driver occurring in a vehicle and deals with an emergency situation, the device executing a program code loaded in one or more memory devices through one or more processors, in which the program code is executed to photograph the driver by using a camera installed in an inside of the vehicle and acquiring first image data, remove noise from the first image data to acquire second image data, and determine whether the driver is an elderly person based on an elderly person's recognizable point in the second image data, perform an emotion classification on the driver through facial expression recognition on the second image data, calculate a heart rate of the driver for the second image data, determine, based on a result of the emotion classification and the heart rate, whether the driver is in the emergency situation, when it is determined that the driver is in the emergency situation, output a first request requesting a response from the driver, and when there occurs no response to the first request from the driver within a predetermined time period, transmit an emergency rescue request to an external system.

In some exemplary embodiments, the program code may be executed to further, when there occurs the response of the driver to the first request within the predetermined time period, output a second request requesting a response from the driver indicating whether the driver consents to transferring a right of control of the vehicle, and when there occurs the response indicating that the driver consents to the transferring of the right of the control of the vehicle, transfer the right of the control of the vehicle to another entity.

In some exemplary embodiments, the transferring of the right of the control of the vehicle to another entity may include transferring the right of the control of the vehicle to a remote server that is capable of controlling the vehicle remotely.

In some exemplary embodiments, the transferring of the right of the control of the vehicle to another entity may include transferring the right of the control to an in-vehicle computing device capable of controlling the vehicle to perform autonomous driving.

In some exemplary embodiments, the program code may be executed to further, when there occurs the response indicating that the driver does not consent to the transferring of the right of the control of the vehicle, repeatedly photograph the driver by using the camera and determining whether the driver is in the emergency situation.

In some exemplary embodiments, the elderly person's recognizable point may include hair regions and wrinkle regions, and the determining of whether the driver is the elderly person may include predicting whether the driver is an elderly person from the second image data by using a first model trained to predict presence of gray hair and presence of wrinkles from the point.

In some exemplary embodiments, the performing of the emotion classification on the driver may include: extracting a global feature, to which multi-scale is applied, from the second image data via a multi-scale module including a plurality of multi-scale blocks with different sized filters; extracting a local feature, to which attention is applied, from the second image data, via a convolutional block attention module (CBAM) that includes a channel attention module and a spatial attention module, and sequentially applies the channel attention module and the spatial attention module; inputting the global feature and the local feature into a graph convolutional network (GCN) combiner to perform feature combination; and performing an emotion classification on the driver by using a classifier based on the combined feature.

In some exemplary embodiments, the program code may be executed to further select a superior feature by applying a feature selector to the global feature and the local feature, and extract a patch image of the face corresponding to a location of the superior feature from the global feature, and the performing of the feature combination may include: performing the feature combination by inputting the feature acquired by enlarging the patch image and applying attention to the enlarged patch image into the graph convolutional network combiner together with the global feature and the local feature.

In some exemplary embodiments, the calculating of the heart rate of the driver may include: acquiring a first band image and a second band image of different bands from the second image data; measuring a first remote heartbeat signal and a second remote heartbeat signal for the first band image and the second band image, respectively; computing a first quality score and a second quality score for the first band image and the second band image, respectively; selecting a first effective heart rate section based on the first remote heartbeat signal and the first quality score; selecting a second effective heart rate section based on the second remote heartbeat signal and the second quality score; and calculating a complementary heart rate based on the first effective heart rate section and the second effective heart rate section.

In some exemplary embodiments, the computing of the first quality score and the second quality score may include: at least one of computing a first movement quality score and a second movement quality score; computing a first lighting quality score and a second lighting quality score; and computing a first signal quality score and a second signal quality score.

According to the exemplary embodiments, it is possible to detect a driver's emergency situation quickly in a non-contact manner and provide a dealing method suitable to the emergency situation based on the driver's state of consciousness or cognition

Although the above example embodiments of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A method performed by an apparatus of a vehicle, the method comprising:
obtaining, via a camera of the vehicle, image data representing one or more photographic images of a driver of the vehicle;
determining, based on the image data having one or more pre-determined image characteristics, that the driver satisfies an age threshold;
determining, based on performing a facial expression analysis on the image data, an emotion classification of the driver;
determining a value associated with a heart rate of the driver, wherein the value associated with the heart rate corresponds to the image data;
determining, based on the driver satisfying the age threshold, based on the emotion classification, and based on the heart rate, presence of an emergency situation;
outputting, via a user interface of the vehicle and based on the presence of the emergency situation, a first request for a user response from the driver; and
transmitting, to an emergency dispatch service provider and based on receiving no user response from the driver within a predetermined time period after the first request is output, an emergency rescue request.

2. The method of claim 1, further comprising:
outputting, via the user interface of the vehicle and based on presence of a second emergency situation, a second request for a user response from the driver;
outputting, via the user interface and based on receiving a user response to the second request, a third request for an indication of consent by the driver to transferring a right of control of the vehicle; and
transferring, based on receiving the indication of consent, the right of control of the vehicle to an entity different from the driver.

3. The method of claim 2, wherein the entity comprises a remote server that is configured to control the vehicle remotely.

4. The method of claim 2, wherein the entity comprises a computing device located in the vehicle and configured to control the vehicle to perform autonomous driving.

5. The method of claim 1, further comprising:
outputting, via the user interface and based on receiving no user response from the driver within the predetermined time period, a second request for an indication of consent by the driver to transferring a right of control of the vehicle; and
based on not receiving the indication of consent within the predetermined time period, obtaining, via the camera, additional image data representing one or more additional photographic images of the driver and confirming, based on the additional image data, presence of the emergency situation.

6. The method of claim 1, wherein the one or more pre-determined image characteristics are associated with at least one of hair of the driver or a wrinkle of the driver, and
wherein the determining that the driver satisfies the age threshold comprises:
estimating an age of the driver based on the image data by using a first model trained to identify presence of gray hair and presence of wrinkles.

7. The method of claim 1, wherein the determining of the emotion classification comprises:
determining, based on the image data, a global feature, to which multi-scale is applied, from the image data via a plurality of multi-scale blocks with different sized filters;
determining a local feature, to which attention is applied, from the image data, via a convolutional block attention module (CBAM) that includes a channel attention module and a spatial attention module, and sequentially applies the channel attention module and the spatial attention module;
inputting the global feature and the local feature into a graph convolutional network (GCN) combiner to perform feature combination; and
determining the emotion classification of the driver by using a classifier based on a result of the feature combination.

8. The method of claim 7, further comprising:
selecting a superior feature by applying a feature selector to the global feature and the local feature; and
extracting, from the global feature, a patch image of a face corresponding to a location of the superior feature,
wherein the performing of the feature combination comprises:
performing the feature combination by inputting a feature acquired by enlarging the patch image and applying attention to the enlarged patch image to the GCN combiner with the global feature and the local feature.

9. The method of claim 1, wherein the determining of the heart rate of the driver comprises:
obtaining a first band image and a second band image of different bands from the image data;
measuring a first remote heartbeat signal for the first band image;
measuring a second remote heartbeat signal for the second band image;
determining, based on the first band image, a first quality score;
determining, based on the second band image, a second quality score;
determining, based on the first remote heartbeat signal and the first quality score, a first effective heart rate section;
determining, based on the second remote heartbeat signal and the second quality score, a second effective heart rate section; and
determining, based on the first effective heart rate section and the second effective heart rate section, a complementary heart rate.

10. The method of claim 9, wherein the determination of the first quality score and the second quality score comprises at least one of:
determining a first movement quality score and a second movement quality score;
determining a first lighting quality score and a second lighting quality score; and
determining a first signal quality score and a second signal quality score.

11. An apparatus comprising:
one or more processors; and
memory storing instructions that, when executed by the one or more processors, cause the apparatus to:
obtain, via a camera of a vehicle, image data representing one or more photographic images of a driver of the vehicle;
determine, based on the image data having one or more pre-determined image characteristics, that the driver satisfies an age threshold;
determine, based on performing a facial expression analysis on the image data, an emotion classification of the driver;
determine a value associated with a heart rate of the driver, wherein the value associated with the heart rate corresponds to the image data;
determine, based on the driver satisfying the age threshold, based on the emotion classification, and based on the heart rate, presence of an emergency situation;
output, via a user interface of the vehicle and based on the presence of the emergency situation, a first request for a user response from the driver; and
transmit, to an emergency dispatch service provider and based on receiving no user response from the driver within a predetermined time period after the first request is output, an emergency rescue request.

12. The apparatus of claim 11, wherein the instructions, when executed by the one or more processors, further cause the apparatus to:
output, via the user interface and based on receiving a user response from the driver within the predetermined time period, a second request for an indication of consent by the driver to transferring a right of control of the vehicle, and
transfer, based on receiving the indication of consent, the right of control of the vehicle to an entity different from the driver.

13. The apparatus of claim 12, wherein the entity comprises a remote server that is configured to control the vehicle remotely.

14. The apparatus of claim 12, wherein the entity comprises a computing device located in the vehicle and configured to control the vehicle to perform autonomous driving.

15. The apparatus of claim 11, wherein the instructions, when executed by the one or more processors, further cause the apparatus to:
output, via the user interface and based on receiving no user response from the driver within the predetermined time period, a second request for an indication of consent by the driver to transferring a right of control of the vehicle; and
based on not receiving the indication of consent within the predetermined time period, obtain, via the camera, additional image data representing one or more additional photographic images of the driver and confirm, based on the additional image data, presence of the emergency situation.

16. The apparatus of claim 11, wherein the one or more pre-determined image characteristics are associated with at least one of hair of the driver or a wrinkle of the driver, and
wherein the instructions, when executed by the one or more processors, cause the apparatus to determine that the driver satisfies the age threshold by:
estimating an age of the driver based on the image data by using a first model trained to identify presence of gray hair and presence of wrinkles.

17. The apparatus of claim 11, wherein the instructions, when executed by the one or more processors, cause the apparatus to determine the emotion classification by:
determining, based on the image data, a global feature, to which multi-scale is applied, from the image data via a plurality of multi-scale blocks with different sized filters;
determining a local feature, to which attention is applied, from the image data, via a convolutional block attention module (CBAM) that includes a channel attention module and a spatial attention module, and sequentially applies the channel attention module and the spatial attention module;
inputting the global feature and the local feature into a graph convolutional network (GCN) combiner to perform feature combination; and
determining the emotion classification of the driver by using a classifier based on a result of the feature combination.

18. The apparatus of claim 17, wherein the instructions, when executed by the one or more processors, further cause the apparatus to:
select a superior feature by applying a feature selector to the global feature and the local feature; and
extract, from the global feature, a patch image of a face corresponding to a location of the superior feature, and
wherein the instructions, when executed by the one or more processors, cause the apparatus to perform the feature combination by:
performing the feature combination by inputting a feature acquired by enlarging the patch image and applying attention to the enlarged patch image to the GCN combiner with the global feature and the local feature.

19. The apparatus of claim 11, wherein the instructions, when executed by the one or more processors, cause the apparatus to determine the heart rate of the driver by:
obtaining a first band image and a second band image of different bands from the image data;
measuring a first remote heartbeat signal for the first band image;
measuring a second remote heartbeat signal for the second band image;
determining, based on the first band image, a first quality score;
determining, based on the second band image, a second quality score;
determining, based on the first remote heartbeat signal and the first quality score, a first effective heart rate section;
determining, based on the second remote heartbeat signal and the second quality score, a second effective heart rate section; and
determining, based on the first effective heart rate section and the second effective heart rate section, a complementary heart rate.

20. The apparatus of claim 19, wherein the instructions, when executed by the one or more processors, cause the apparatus to determine the first quality score and the second quality score by:
determining a first movement quality score and a second movement quality score;
determining a first lighting quality score and a second movement lighting score; and
determining a first signal quality score and a second signal quality score.
